(19) United States
(12) Patent Application Publication
(10) Pub. No.: US 2012/0007279 A1
(43) Pub. Date: Jan. 12, 2012

(54) HOLDING DEVICE, IMPRINT APPARATUS, AND ARTICLE MANUFACTURING METHOD

(75) Inventor: Hirotoshi TORII, Utsunomiya-shi (JP)

(73) Assignee: CANON KABUSHIKI KAISHA, Tokyo (JP)

(21) Appl. No.: 13/176,869

(22) Filed: Jul. 6, 2011

(30) Foreign Application Priority Data
Jul. 12, 2010 (JP) 2010-157845

(51) Int. Cl. B29C 59/02; B29C 33/30

(52) U.S. Cl. 264/293; 425/150; 425/385

(57) ABSTRACT

A holding device of the present invention for holding a mold, the device includes a holder configured to attract the mold to hold the mold; an actuator supported by the holder so as to face a side of the mold, and configured to apply a force to the side to deform the mold; and a detector supported by the holder so as to face the side, and configured to detect a position of the side in a direction of the force. Here, the detector is configured to detect, as the position, a position of a first region in the side, the actuator is configured to apply the force to a second region in the side, and the second region is around the first region.

### BACKGROUND OF THE INVENTION

1. Field of the Invention

The present invention relates to a holding device, an imprint apparatus, and an article manufacturing method.

2. Description of the Related Art

As the demand for microfabrication of semiconductor devices increases, not only a conventional photolithography technology but also a microfabrication technology in which a mold and an uncured resin on a substrate are pressed against each other to thereby form a resin pattern, which corresponds to the fine concave and convex pattern formed on the mold, on the substrate have attracted attention. This technology is also referred to as an “imprint technology”, by which a fine structure with dimensions of a few nanometers can be formed on the substrate. One example of imprint technologies includes a photo-curing method. The photo-curing method first applies an ultraviolet curable resin (imprinting resin, photocurable resin) to the shot area (imprinting area) on the substrate (wafer). Next, the resin (uncured resin) and a mold are pressed against each other. After the ultraviolet curable resin is irradiated with ultraviolet light for curing, the cured resin is released from the mold, whereby a resin pattern is formed on the substrate.

In general, the imprint apparatus employing the aforementioned technology includes a magnification correction mechanism that corrects the magnification error of a pattern developed during a semiconductor process. The magnification correction mechanism is constituted by a driving unit, a sensor for controlling the drive quantity of the driving unit, and the like. The magnification correction mechanisms are installed in plural locations so as to enclose the outer circumference portion of a mold. In this case, the driving unit imparts an external force to a mold to thereby cause the mold itself to be deformed, so that the pattern shape formed on the mold is corrected. At this time, since the pattern shape affects the superposition accuracy of the patterns, a highly accurate correction with dimensions of less than a few nanometers is required in order to compensate the micronization of a pattern. Japanese Patent Laid-Open No. 2008-504141 discloses a correction device that applies a compressive force to the mold-side surface to thereby perform magnification correction. Also, Japanese Patent Laid-Open No. 2009-141328 discloses an imprint apparatus in which an actuator which applies a compressive force to the mold-side surface is installed between the mold-side surface and the supporting structure body, and the drive quantity of the actuator is controlled by a force sensor installed between the actuator and the supporting structure body.

Furthermore, when a resin is filled in the concave and convex pattern of a mold, it is preferable that the required-amount of gas such as helium or the like be supplied from the outer circumference portion to the filling portion of the mold in order to suppress air bubbles coming from the filling portion, as well as reduce defects in the pattern to be formed. Thus, in general, the imprint apparatus includes a gas supplying device arranged close to the mold.

Japanese Patent Laid-Open No. 2008-504141 discloses a correction device that is constituted by an actuator and a link mechanism. The total sixteen correction devices are installed so as to enclose the circumferential surfaces of a mold. However, when a pattern shape correction is required with high accuracy, the number of correction devices installed may be further increased. In addition to the correction devices, the gas supplying devices, position sensors for measuring the position of a mold, and the like, as described above, are installed in the imprint apparatus at plural locations on the outer circumference portion of the mold. Thus, in this case, the space in the outer circumference portion of a mold is not sufficient for arranging various mechanisms, and thus, a location for installing a further sensor cannot be ensured. Also, the piping space for the gas supplying devices is limited, and thus, the amount of gas supplied may be insufficient.

As with the imprint apparatus disclosed in Japanese Patent Laid-Open No. 2009-141328, when the drive quantity is controlled by a force sensor, the drive quantity is readily affected by contact friction between a mold and a driving unit. Also, the output value of the force sensor may be changed depending on various forces generated by an imprinting operation or a mold-release operation. Therefore, measurement error of the drive quantity may occur due to the change in the output value, and thus, a highly-accurate mold shape correction may be difficult.

Furthermore, the change in the position of a mold upon exchange thereof also affects the superposition accuracy of the patterns. Thus, the positional shift upon mold exchange needs to be monitored, and the heat generated from the driving unit upon correction of the positional shift needs to be suppressed. Furthermore, since a force is imparted to a mold during an imprinting operation and a mold-release operation, the deformation amount and the position of a mold needs to be monitored.

### SUMMARY OF THE INVENTION

In view of the foregoing, the present invention provides a holding device that is advantageous in terms of adjusting at least one of a shape and position of a mold.

According to an aspect of the present invention, A holding device for holding a mold, the device includes a holder configured to attract the mold to hold the mold; an actuator supported by the holder so as to face a side of the mold, and configured to apply a force to the side to deform the mold; and a detector supported by the holder so as to face the side, and configured to detect a position of the side in a direction of the force, wherein the detector is configured to detect, as the position, a position of a first region in the side, the actuator is configured to apply the force to a second region in the side, and the second region is around the first region.

According to the present invention, a holding device that is advantageous in terms of adjusting at least one of a shape and position of a mold may be provided.

Further features of the present invention will become apparent from the following description of exemplary embodiments with reference to the attached drawings.

### BRIEF DESCRIPTION OF THE DRAWINGS

FIG. 1 is a schematic view illustrating the configuration of an imprint apparatus according to an embodiment of the present invention.

FIG. 2 is a schematic view illustrating the configuration of a mold holding device according to a first embodiment.

FIG. 3A is a cross-sectional view illustrating the configuration of a magnification correction mechanism corresponding to the line A-A′ shown in FIG. 2.

FIG. 3B is a perspective view illustrating the configuration of a magnification correction mechanism when viewed from the mold side.

FIG. 4 is a flowchart illustrating the operation of an imprint apparatus according to a first embodiment.

FIG. 5A is a schematic view illustrating the configuration of a mold holding device according to a second embodiment.

FIG. 5B is a schematic view illustrating the configuration of another mold holding device according to a second embodiment.

FIG. 6 is a flowchart illustrating the operation of an imprint apparatus according to a fourth embodiment.

### DESCRIPTION OF THE EMBODIMENTS

Hereinafter, preferred embodiments of the present invention will now be described with reference to the accompanying drawings.

### (Imprint Apparatus)

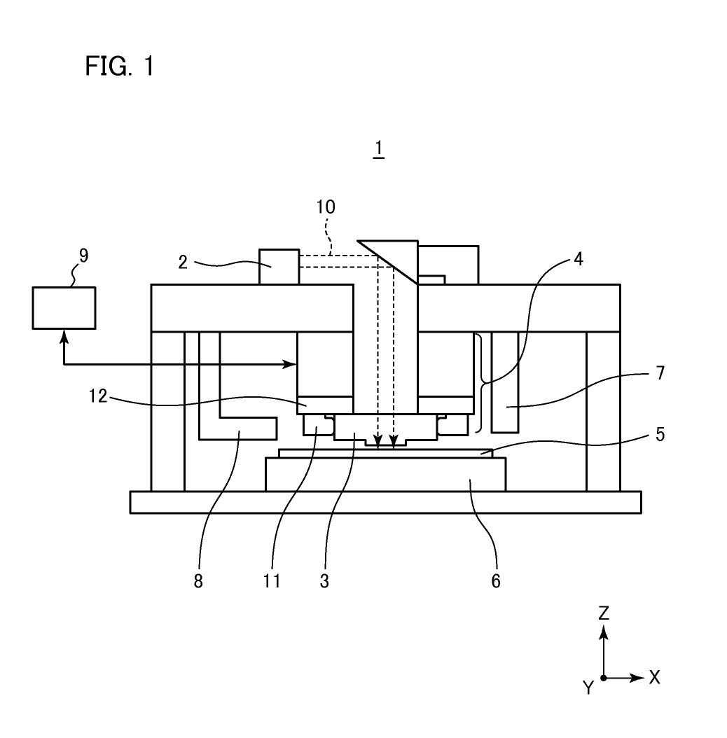

Firstly, a description will be given of the configuration of an imprint apparatus according to an embodiment of the present invention. FIG. 1 is a schematic view illustrating the configuration of an imprint apparatus. The imprint apparatus according to the present embodiment is a processing apparatus that transfers the concave and convex pattern of a mold onto a wafer (a substrate), i.e., a treatment object substrate, which is used for a semiconductor device manufacturing process, and is an apparatus that employs a photo-curing method used in imprint technologies. In the following drawings, a description will be given where the Z axis is aligned in parallel to the irradiation axis of ultraviolet light for a mold, the X axis is aligned in the direction in which a wafer moves with respect to a mold base to be described below in a plane perpendicular to the Z axis, and the Y axis is aligned in the direction perpendicular to the X axis. The imprint apparatus 1 of the present invention includes an illumination unit 2, a mold holding device 4, a wafer stage 6, an application unit 7, a mold conveying unit 8, and a controller 9.

The illumination unit 2 irradiates a mold 3 with an ultraviolet light 10 during imprinting processing. The illumination unit 2 is constituted by a light source and a plurality of optical elements that adjust ultraviolet light emitted from the light source to a light suitable for imprinting. Also, the mold 3 has a rectangular shape at an outer periphery thereof and is a mold (mold material, die) in which a predetermined pattern (e.g., the concave and convex pattern of a circuit pattern or the like) is three-dimensionally formed on the opposite surface of the wafer 5. The surface of the concave and convex pattern is processed at high flatness so as to maintain the adhesion between the wafer 5 and the surface. Note that the material of the mold 3 is a material such as quartz or the like through which ultraviolet light can pass.

The mold holding device 4 is a holding device that holds and fixes the mold 3. The mold holding device 4 includes a magnification correction mechanism 11 that corrects the concave and convex pattern formed on the mold 3 into a desired shape by applying a compressive force to the mold 3, and a mold base (holder) 12 that draws and holds the mold 3 by an attraction force or an electrostatic force. Also, the mold holding device 4 includes a base driving mechanism (not shown) that drives the mold base 12. More specifically, the base driving mechanism is a driving system that drives the mold base 12 in the Z-axial direction so as to press the mold 3 against an ultraviolet curable resin formed on the wafer 5. An actuator employed for the driving mechanism is not particularly limited provided that it can drive at least in the Z-axial direction. A linear motor, an air cylinder, or the like can be employed. Alternatively, in order to perform a mold-release operation with high precision so as to prevent the cured ultraviolet curable resin from being damaged when a mold-release operation for releasing the mold 3 from the ultraviolet curable resin is performed, an actuator may be employed to carry out a coarse operation and a micro operation in a segmented manner. The imprinting operation and the mold-release operation may be realized by driving the mold 3 in the Z-direction as described above or may also be realized by driving the wafer stage 6 (the wafer 5) in the Z-direction.

The wafer 5 is a treatment object substrate consisting of, for example, a single crystal silicon, and the ultraviolet curable resin (hereinafter referred to simply as “resin”), which serves as a portion to be molded, is applied on the treatment surface. Also, the wafer stage 6 is a substrate holder configured to hold the wafer 5 by vacuum suction and be freely moveable in the XY plane. As an actuator for driving the wafer stage 6, a linear motor can be employed, but this is not particularly limiting. Also, the application unit (dispenser) 7 is an application unit configured to apply an uncured resin to the wafer 5. A resin is a photocurable resin (imprinting material) having curing characteristics that is cured by ultraviolet light, and is appropriately selected depending on the type of a semiconductor device to be manufactured. Furthermore, the mold conveying unit 8 conveys the mold 3 and installs it on the mold base 12.

The controller 9 controls the operation, adjustment, and the like of the components of the imprint apparatus 1. The controller 9 is constituted by a computer, a sequencer, or the like having a storage unit (not shown) such as a magnetic storage medium or the like that is connected to the components of the imprint apparatus 1 through a line, and executes control of the components by a program or a sequence. In particular, in the present embodiment, the controller 9 adjusts the clamping force (attraction force) of the mold base 12 as appropriate, and controls the operation of the magnification correction mechanism 11, the gas supplying device, and the like constituting the mold holding device 4 to be described below. Note that the controller 9 may be integrated with the imprint apparatus 1, or may be installed at a location separate from the location where the imprint apparatus 1 is installed to thereby be controlled remotely.

### First Embodiment

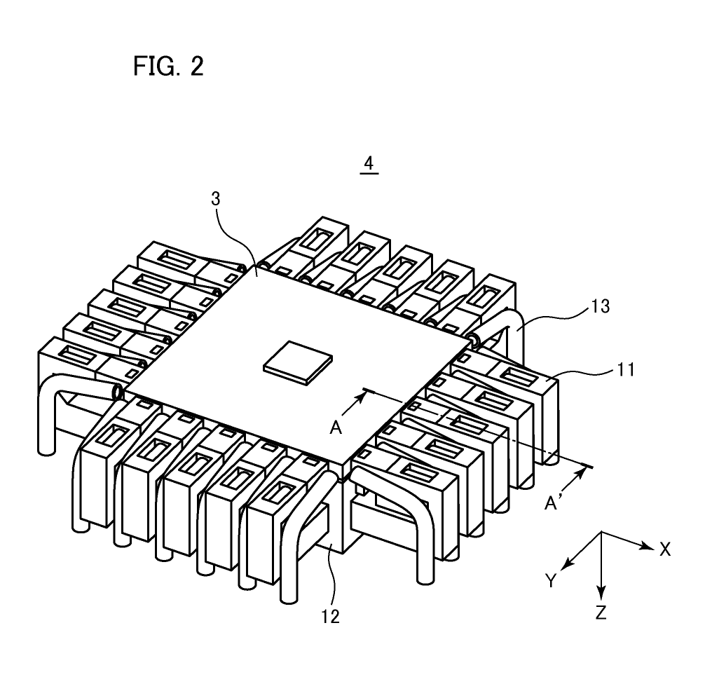

Next, a description will be given of a mold holding device according to the first embodiment of the present invention. FIG. 2 is a perspective view illustrating the configuration of the mold holding device 4 according to the present embodiment, which is installed in the imprint apparatus 1, as viewed from the wafer 5 side. The mold holding device 4 includes a plurality of magnification correction mechanisms 11 that are arranged facing the four side surface regions of the mold 3, and a plurality of pipes 13 that are arranged in the same line as the magnification correction mechanisms 11 and supplies (recovers) gas to a region adjacent to the side surface of the mold 3. In the present embodiment, as shown in FIG. 2, five magnification correction mechanisms 11 are installed on one side surface of the mold 3, that is to say, twenty magnification correction mechanisms 11 in total are installed around the mold 3. Likewise, six pipes (supply pipes and recovery pipes) 13 are installed on one side surface of the mold 3 between two magnification correction mechanisms 11, that is to say, twenty-four pipes in total are installed around the mold 3. Note that the number of magnification correction mechanisms 11 installed may be changed depending on the desired pattern shape or the desired accuracy as appropriate. Also, the number or shape of the pipes 13 may be changed as appropriate as long as a sufficient amount of gas can be supplied thereto. Furthermore, although the pipes 13 supply the required quantity of gas such as helium or the like from a gas supplying device (not shown), a leakage of gas to be supplied causes a length-measuring error by a length-measuring device, such as an interferometer for position measurement or the like, to be normally installed in the wafer stage 6, and thus sufficient exhaust (recovery) is required.

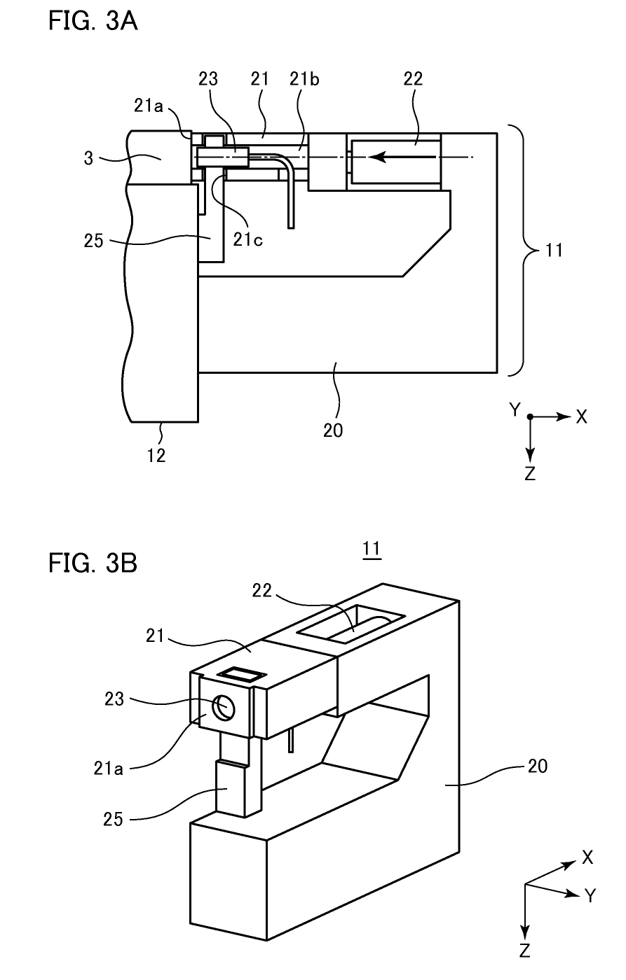

Next, a description will be given of the configuration of the magnification correction mechanism 11. FIG. 3A and FIG. 3B are schematic views illustrating the configuration of the magnification correction mechanism 11. In particular, FIG. 3A is a cross-sectional view taken along the line A-A′ of FIG. 2, and FIG. 3B is a perspective view as viewed from the mold 3 side. As shown in FIG. 3A and FIG. 3B, the magnification correction mechanism 11 includes a supporting member 20 that forms a main body, and a contact member 21 and an actuator 22 that are installed on the supporting member 20. The supporting member 20 is a cubic member having a U-shaped side surface in the Y-axis direction, and is fixed to the side of the mold base 12. The contact member 21, of which a contact surface 21a is brought into contact with the region within the side surface of the outer circumference portion of the mold 3, is a cubic member that is movable in the X-axis direction so as to apply force (compressive force) to the region. Hereinafter, a region in which the contact member 21 (the contact surface 21a) makes contact within the side surface is defined as a “second region”. Also, the actuator 22 is a drive unit that is installed coaxially with the movement axis of the contact member 21 and transmits a driving force (compressive force) to the contact member 21. As the actuator 22, a piezo element, a pneumatic actuator, a linearly moving motor, or the like can be employed. Note that the installation position (relative position) between the contact member 21 and the actuator 22 may be arbitrary. As in the present embodiment, the actuator 22 need not be installed coaxially with the movement axis of the contact member 21.

Furthermore, the magnification correction mechanism 11 includes a position sensor (detector) 23 that measures the position and deformation of the mold 3. As the position sensor 23, an optical sensor, an eddy current sensor, a capacitive sensor, or the like can be employed. Here, in the contact member 21 of the present embodiment, a hole portion 21b is formed from the central portion of the contact surface 21a to the inside of the member, and the position sensor 23 is arranged inside the hole portion 21b. Specifically, the region (hereinafter referred to as a “first region”) within the side surface of the outer circumference portion of the mold 3, of which the position is detected by the position sensor 23, is inside the second region to which a force is applied by the actuator 22. In this case, an inlet port 21c that is provided through the hole portion 21b in the vertical direction is further formed in the contact member 21, and the position sensor 23 is fixed to the mold base 12 and is held to a sensor supporting member 25 that is introduced into the hole portion 21b via the inlet port 21c. Specifically, the position sensor 23 is not substantially in contact with the contact member 21, and the contact member 21 is also movable without making contact with the position sensor 23. In the present embodiment, the entire contact surface 21a is in contact with the side surface region of the mold 3 as shown in FIG. 3A and FIG. 3B. However, a part (e.g., a plurality of points around the measurement position) of the contact surface 21a may be brought into contact therewith.

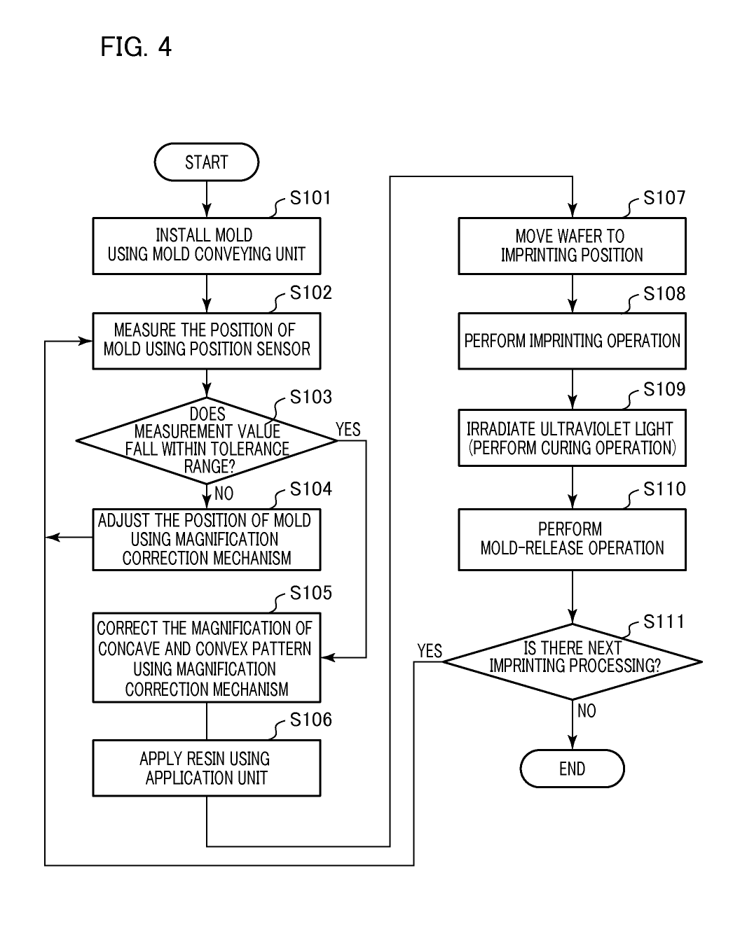

Next, a description will be given of an imprinting processing operation performed by the imprint apparatus 1 to which the mold holding device 4 is installed. FIG. 4 is a flowchart illustrating the operation sequence of imprinting processing. When the operation sequence is started, the controller 9 firstly causes the mold conveying unit 8 to install the mold 3 on the mold base 12 (step S101). Next, the controller 9 causes three position sensors 23, which are installed on at least three magnification correction mechanisms 11 among the respective magnification correction mechanisms 11 of the mold holding device 4, to measure the position of the mold 3 (step S102). In this state, the contact member 21 of the magnification correction mechanism 11 is not in contact with the mold 3. Next, the controller 9 determines whether or not the measurement value (output) measured by the position sensor 23 falls in a preset tolerance range (step S103). Here, when the controller 9 determines that the measurement value does not fall in the tolerance range (NO in step S103), the controller 9 drives the magnification correction mechanism 11 and adjusts the position of the mold 3 by setting at least either one of the desired position or the desired shape as the target value (step S104). After the position of the mold 3 has been adjusted in step S104, the process returns to step S102 again. Next, when the controller 9 determines that the measurement value falls in the tolerance range (YES in step S103), the controller 9 drives the magnification correction mechanism 11 such that the concave and convex pattern of the mold 3 is formed into the desired shape, and then performs magnification correction (step S105). In this case, the magnification correction mechanism 11 deforms the shape of the mold 3 into a concave shape by pressing the contact member 21 against the mold 3 as appropriate. At this time, the amount of deformation is determined by the controller 9 based on the measurement value measured by the position sensor 23.

Next, the controller 9 drives the wafer stage 6 to move the wafer 5 to the application position of the application unit 7, and then causes the application unit 7 to apply a resin to the surface of the wafer 5 (step S106). Next, the controller 9 drives the wafer stage 6 to move the wafer 5 to the imprinting position (step S107). Next, the controller 9 performs an imprinting operation for pressing the mold 3 against the treatment region of the wafer 5 on which the resin is applied, and fills the concave and convex pattern formed on the mold 3 with the resin (step S108). Next, in this state, the controller 9 emits ultraviolet light onto the resin filled within the concave and convex pattern of the mold 3, and solidifies (cures) the resin on the surface of the wafer 5 (step S109: curing processing). Next, the controller 9 performs a mold-release operation for releasing the mold 3 from the wafer 5 (step S110). Then, the controller 9 determines whether or not there is the next imprinting processing in step S111. When the controller 9 determines that there is a next imprinting processing (YES in step S111), the process shifts to step S102 again, whereas when the controller 9 determines that there is no next imprinting processing (NO in step S111), the imprinting processing is ended.

As described above, the controller 9 determines whether or not the measurement value relating to the position and deformation of the mold 3, which is measured by the position sensor 23, falls within a preset tolerance range. Specifically, good measurement accuracy is required for the position sensor 23. Thus, in the present invention, the position sensor 23 is arranged such that it is not in contact with the contact member 21 as described above and its measurement position is the central portion of the contact surface 21a by which a compressive force is actually imparted to the mold 3, resulting in an improvement in measurement accuracy. Furthermore, in the present invention, the position sensor 23 is arranged inside the contact member 21, and thus a large installation space for the pipes 13 can be ensured.

Since a force is applied to the mold 3 during the resin filling operation and the mold-release operation described above, a positional shift in the mold 3 may occur. Hence, the position and deformation of the mold 3 may be monitored by the position sensor 23 point by point. In this case, the controller 9 measures the position of the mold 3 using the position sensor 23 as in step S102 after the mold-release operation in step S110. When the positional shift does not fall in the tolerance range, the positional adjustment of the mold 3 may be performed as in step S104. Also, as an additional method for the positional adjustment of the mold 3 in step S104, the controller 9 may adjust the amount of positional shift, which has been measured by the position sensor 23, by driving the wafer stage 6. While the present embodiment has been described based on the assumption that the mold holding device 4 includes a plurality of pipes 13, the mold holding device 4 may include only a plurality of magnification correction mechanisms 11 that consist of a set of the actuator 22 and the position sensor 23 without installing the pipes 13.

### Second Embodiment

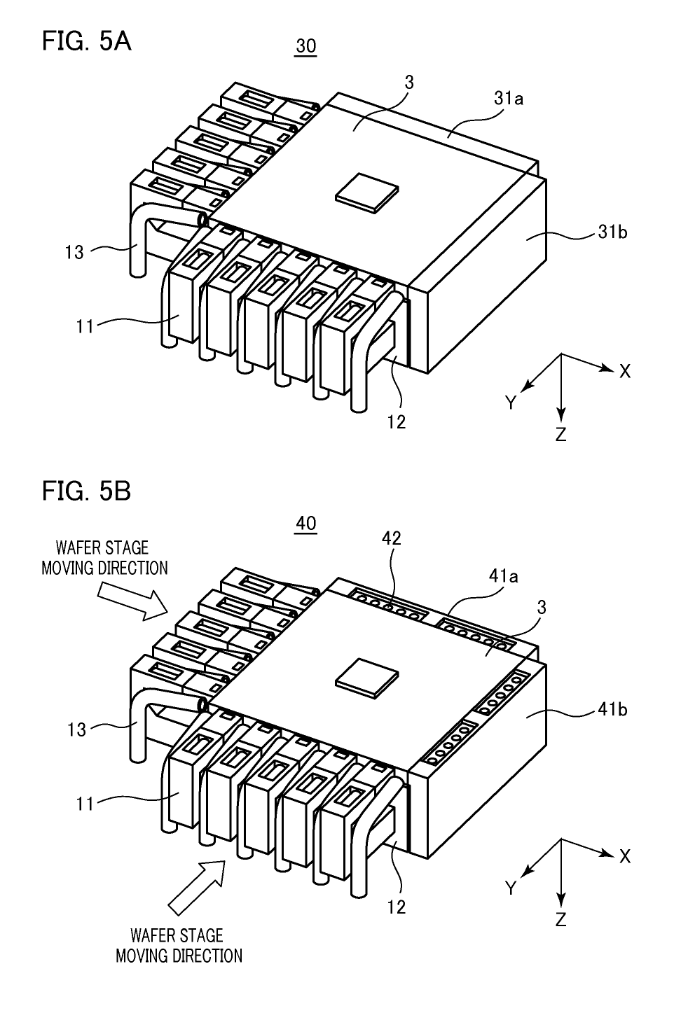

Next, a description will be given of a mold holding device according to a second embodiment of the present invention. FIG. 5A and FIG. 5B are schematic views illustrating the configuration of a mold holding device according to the present embodiment. In FIG. 5A and FIG. 5B, the same elements as those in the mold holding device 4 shown in FIG. 2 are designated by the same reference numerals and explanation thereof will be omitted. In a mold holding device 30 shown in FIG. 5A, the magnification correction mechanisms 11, identical to the ones in the first embodiment, are installed at the two adjacent side surfaces among the side surfaces of the outer circumference portion of the mold base 12, whereas positioning plates 31a and 31b are installed at the other two side surfaces opposite these two side surfaces. Each of the positioning plates 31a and 31b is a cubic member having a longitudinal dimension substantially the same as the length of the side surface of the mold 3, and is in face-to-face contact with the side surface of the mold 3. According to the configuration, the number of the magnification correction mechanisms 11 can be reduced in comparison with the mold holding device 4 of the first embodiment, and thus, the magnification correction of the concave and convex pattern of the mold 3 can be performed in a simple manner.

On the other hand, a mold holding device 40 shown in FIG. 5B is the modification of the mold holding device 30 described above, and a recovery path 42 for recovering gas supplied from the pipes 13 is formed on each of second positioning plates 41a and 41b that correspond to the positioning plates 31a and 31b, respectively. The recovery path 42 has a freely chosen number of recovery openings on the surface of each of the second positioning plates 41a and 41b opposite the wafer 5, and gas recovered from the recovery opening is introduced into a gas recovery device (not shown) via the recovery path 42. According to the configuration, in addition to the aforementioned effects, gas supplied from the pipes 13 can be efficiently recovered by the recovery path 42 that is located at a position opposite the pipes 13, whereby the amount of gas leakage on the periphery of the wafer stage 6 can be reduced. Also, as shown by the arrows of FIG. 5B, the moving direction of the wafer stage 6 is the same as the supply direction of gas, and thus, the efficiency of the supply and the recovery of gas can be further improved. In contrast, gas may be supplied from the side of the second positioning plates 41a and 41b and may be recovered by the side of the magnification correction mechanism 11. In this case, it is desired that the driving direction of the wafer stage 6 be in a direction opposite to the arrows in FIG. 5B.

### Third Embodiment

As a third embodiment of the present invention, the controller 9 may control the mold base 12 so as to reduce a clamping force to such an extent that the mold 3 does not drop off in order to reduce the driving force of the magnification correction mechanism 11 in step S104 shown in FIG. 4 according to the first embodiment. With this arrangement, heating caused by driving of the magnification correction mechanism 11 can be suppressed. In this case, after adjustment of the shape of the mold 3, the controller 9 controls the clamping force imparted by the mold base 12 such that the clamping force is returned to the original state to prevent the mold 3 from being shifted from a desired position. The timing at which the clamping force of the mold base 12 is reduced is at least either upon magnification correction of the mold 3 or upon positional adjustment of the mold 3, and when at least mold-release operation is performed, the controller 9 controls the clamping force of the mold 3 such that the clamping force is restored. Prior to the start of curing a resin or during resin curing, the controller 9 may control the clamping force so as to restore it. Here, when the monitoring and correction of the positional shift of the mold 3 under the control of the clamping force of the mold base 12, during the resin filling operation, or during the mold-release operation are performed in a simple manner, the present invention is not limited to the configuration of the first embodiment. In this case, the position and deformation of the mold 3 can be monitored by the position sensor 23, and thus, the central portion of the contact surface 21a does not need to be monitored as in the position sensor 23.

### Fourth Embodiment

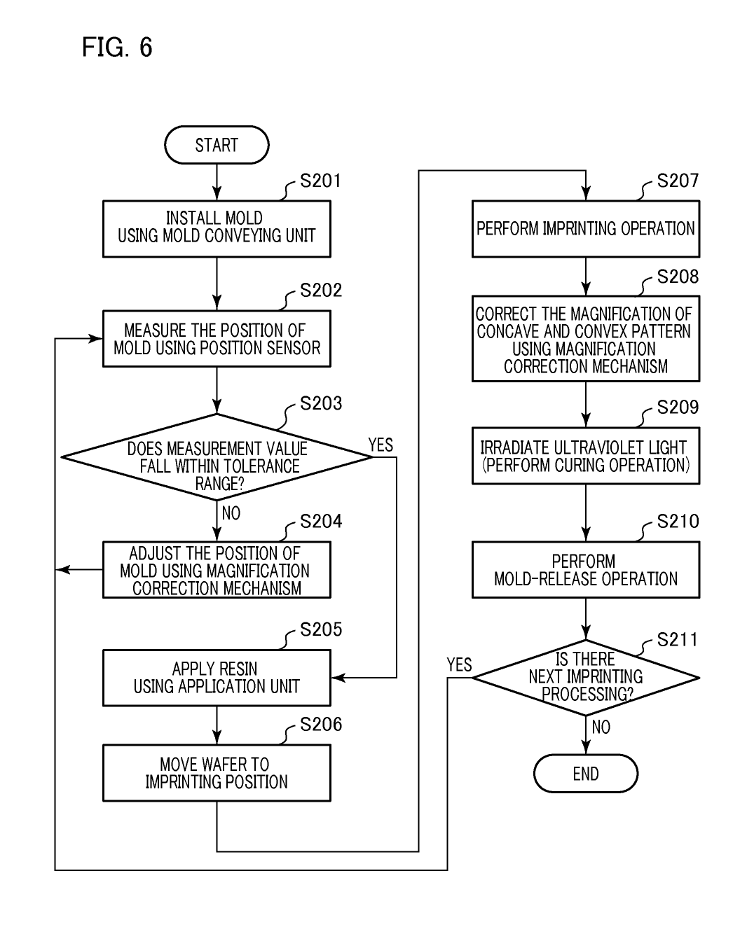

FIG. 6 is a flowchart illustrating an example of an imprinting processing operation according to a fourth embodiment, which is the modification of the imprinting processing operation shown in FIG. 4. In the imprinting processing operation shown in FIG. 6, the timing at which the shape of the concave and convex pattern is corrected by the magnification correction mechanism 11, which corresponds to step S105 in FIG. 4, differs in comparison with the imprinting processing operation shown in FIG. 4. Since the controller 9 normally drives the magnification correction mechanism 11 with the mold 3 held on the mold base 12, a friction force between the mold 3 and the mold base 12 occurs at the time of driving the magnification correction mechanism 11. Thus, a required driving force increases in this case. Hence, in the imprinting processing operation shown in FIG. 6, the controller 9 performs magnification correction using the magnification correction mechanism 11 in a time period from after the start of the imprinting operation to before the start of resin curing (step S208). In this manner, the mold 3 is in contact with the wafer 5 via a resin during the imprinting operation, and thus, the clamping force imparted by the mold base 12 can be reduced. Therefore, since the controller 9 drives the magnification correction mechanism 11 with the clamping force reduced, a required driving force can be reduced. Consequently, heating caused by driving of the magnification correction mechanism 11 can be suppressed. In this case, after the magnification correction has been performed in step S208, the controller 9 restores the clamping force imparted by the mold base 12 so as not to displace the installation position of the mold 3. Note that the other processing operations shown in FIG. 6 are the same as the processing operations shown in FIG. 4 and thus explanation thereof will be omitted.

Although the aforementioned embodiment is configured as shown in, for example, FIG. 2 such that the magnification correction mechanism 11 applies a compressive force to the region of the circumferential surfaces of the mold 3, the present invention is not limited thereto. For example, the magnification correction mechanism 11 may be configured such that a protrusion(s) (not shown) is formed on the side of the mold base 12 of the mold 3 and a compressive force is applied to the regions of the protrusion(s).

### (Article Manufacturing Method)

A method of manufacturing devices (a semiconductor integrated circuit element, liquid crystal display element, and the like) as an article includes a process for transferring (forming) a pattern on a substrate (a wafer, glass plate, or film-like substrate) using the aforementioned imprint apparatus. Furthermore, the manufacturing method can include a process for etching the substrate on which the pattern is transferred. Note that upon manufacturing other articles such as patterned media (recording media) or optical elements, the manufacturing method can include other process for processing the substrate on which the pattern is transferred in place of etching. The article manufacturing method of this embodiment has an advantage, as compared with a conventional article manufacturing method, in at least one of performance, quality, productivity and production cost of an article.

While the embodiments of the present invention have been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-157845 filed Jul. 12, 2010 which is hereby incorporated by reference herein in its entirety.

What is claimed is:

1. A holding device for holding a mold, the device comprising:
a holder configured to attract the mold to hold the mold;
an actuator supported by the holder so as to face a side of the mold, and configured to apply a force to the side to deform the mold; and
a detector supported by the holder so as to face the side, and configured to detect a position of the side in a direction of the force,
wherein the detector is configured to detect, as the position, a position of a first region in the side, the actuator is configured to apply the force to a second region in the side, and the second region is around the first region.

2. The holding device according to claim 1, wherein the actuator includes a contact member that contacts the second region, and the detector is disposed inside the contact member.

3. The holding device according to claim 1, wherein the device comprises a plurality of sets each of which includes the actuator and the detector.

4. The holding device according to claim 3, further comprising:
a supply pipe configured to supply a gas to a region adjacent to the side,
wherein the supply pipe is disposed between adjacent two of the plurality of sets.

5. The holding device according to claim 3, further comprising:
a recovery pipe configured to recover a gas from a region adjacent to the side,
wherein the recovery pipe is disposed between adjacent two of the plurality of sets.

6. A holding device for holding a mold, the device comprising:
a holder configured to attract the mold to hold the mold;
an actuator supported by the holder so as to face a side of the mold, and configured to apply a force to the side to deform the mold;
a detector supported by the holder so as to face the side, and configured to detect a position of the side in a direction of the force; and
a controller configured to control the actuator so that a position of the mold is a target position based on an output of the detector.

7. A holding device for holding a mold, the device comprising:
a holder configured to attract the mold to hold the mold;
an actuator supported by the holder so as to face a side of the mold, and configured to apply a force to the side to deform the mold;
a detector supported by the holder so as to face the side, and configured to detect a position of the side in a direction of the force; and
a controller configured to cause the holder to reduce a force to attract the mold, and to control the actuator so that at least one of a position and shape of the mold is a target value based on an output of the detector.

8. An imprint apparatus for imprinting a pattern on a substrate with a mold, the apparatus comprising:
a holding device, defined in claim 1, for holding the mold.

9. An imprint apparatus for imprinting a pattern on a substrate with a mold, the pattern being imprinted on the substrate via molding of an uncured imprint material on the substrate with the mold, and curing of the molded imprint material, the apparatus comprising:
a holder configured to attract the mold to hold the mold;
an actuator supported by the holder so as to face a side of the mold, and configured to apply a force to the side to deform the mold;
a detector supported by the holder so as to face the side, and configured to detect a position of the side in a direction of the force; and
a controller configured to cause the holder to reduce a force to attract the mold in a period between start of the molding and a start of the curing, and to control the actuator so that at least one of a position and shape of the mold is a target value based on an output of the detector.

10. A method of manufacturing an article, the method comprising:
imprinting a pattern on a substrate with a mold using an imprint apparatus defined in claim 8; and
processing the substrate, on which the pattern has been imprinted, to manufacture the article.

11. A method of manufacturing an article, the method comprising:
imprinting a pattern on a substrate with a mold using an imprint apparatus defined in claim 9; and
processing the substrate, on which the pattern has been imprinted, to manufacture the article.
